(19) United States
(12) Patent Application Publication
(10) Pub. No.: US 2010/0141432 A1
(43) Pub. Date: Jun. 10, 2010

(54) CORRECTING AND/OR IMPROVING LOCATION INFORMATION USING OBJECT LOCATION HISTORY, TOPOLOGY, AND/OR OTHER INFORMATION

(76) Inventor: Binay Sugla, Holmdel, NJ (US)

Correspondence Address: STRAUB & POKOTYLO, 788 Shrewsbury Avenue, TINTON FALLS, NJ, 07724, US

(21) Appl. No.: 12/582,593

(22) Filed: Oct. 20, 2009

Related U.S. Application Data
(60) Provisional application No. 61/136,973, filed on Oct. 20, 2008.

(51) Int. Cl. G08B 1/08; G08B 5/22

(52) U.S. Cl. 340/539.13; 340/825.49

(57) ABSTRACT

A zone location of a tracked object may be refined by (a) accepting first location information derived from a first location technology, (b) generating a set of at least two candidate location zones using the first location, topology information and an accuracy range for the first location technology, (c) for each of the at least two candidate location zones, (1) establishing a path from a previous location zone to the given candidate location zone, and (2) storing, by the computer system and in association with the candidate zone, any location zones on the path, and (d) applying at least one of (A) path-based candidate location zone elimination to each of the at least two candidate location zones, and (B) object-physics-based candidate location zone elimination to each of the at least two candidate location zones, to generate a refined set of at least one candidate location zone.

### §0. PRIORITY CLAIM

This application claims the benefit of U.S. Provisional Patent Application Ser. No. 61/136,973 (incorporated herein by reference and referred to as “the '973 provisional”), titled “METHODS FOR CORRECTING AND IMPROVING LOCATION BASED ON HISTORY, TOPOLOGY, AND OTHER INFORMATION,” filed on Oct. 20, 2008, and listing Binay SUGLA as the inventor. The present invention is not limited to requirements of the particular embodiments described in the '973 provisional.

### §1. BACKGROUND OF THE INVENTION

§1.1 Field of the Invention

The present invention concerns locating a tracked object. In particular, the present invention concerns improving the determination of a location of a tracked object, such as the determination of one of a plurality of zones of a building in which the tracked object is located.

§1.2 Background Information

The importance of determining the location of an object is well recognized. The ubiquity of GPS for outdoor use and increasing prevalence of passive RFID and other tracking technologies (such as Wi-Fi-based tracking) for indoor use has given rise to a number of useful applications with far reaching consequences on business processes and individual convenience and productivity.

However, all methods for locating and tracking objects are prone to errors and/or limitations irrespective of the techniques used for tracking. For example, with RF technologies, a wireless signal may be obstructed by structures, or reflections can cause confusion on the path the signal may have taken, or there may be inherent limitations on the accuracy that can potentially be achieved using the technique.

For many applications, it is highly desirable to come up with a better estimate of the location of a tracked object. For example, in GPS-based outdoor navigation, higher accuracy means less chances of getting lost. Within an indoor environment, consider an object near a wall. If the accuracy of the location technology used is only 10 feet, then which side of the wall the object is on (which in turn could cause confusion in which room the object is in) may be ambiguous. Consider, for example, the object 110 located in room D of the office depicted in FIG. 1. Given an accuracy limitation indicated by circle 120, the object 110 could be located in any one of rooms C, D, F, G, or H. As can be appreciated from this simple example, without the ability to resolve ambiguities, the usefulness of systems for locating objects may be limited. Merely improving the location technology to improve accuracy (and reduce the circle of error) might be prohibitively expensive.

Thus, there is a need to improve systems for locating objects, such as systems for locating objects within a building.

### 2. SUMMARY OF THE INVENTION

Embodiments consistent with the present invention may correct and/or improve an estimated location of a tracked object by further considering one or more of: historical path information of the tracked object; knowledge of the topology of the indoor and the outdoor terrain; understanding of physics (such as, how fast is the object moving, how fast can the object move, what capabilities it may have, etc.); and ancillary sensor devices (such as, for example, gyroscopes, accelerometers, etc.).

### 3. BRIEF DESCRIPTION OF THE DRAWINGS

FIG. 1 illustrates a tracked object within a building floor plan.

FIG. 2 is a bubble diagram of operations that may be performed, and information that may be used and/or generated by such operations.

FIG. 3 is a flow diagram of an exemplary method for refining (e.g., resolving ambiguities in) a zone location of a tracked object.

FIG. 4 is a flow diagram of an exemplary path-based candidate location zone elimination method.

FIG. 5 is a flow diagram of an exemplary object-physics-based candidate location zone elimination method.

FIG. 6 is a building floor plan for illustrating the partitioning of an area into rooms and a common area.

FIG. 7 is a building floor plan for illustrating the partitioning of an area into rooms and virtual areas.

FIG. 8 is a graph representing the connectivity of areas and rooms in the building floor plan of FIG. 6.

FIG. 9 is a graph representing the connectivity of virtual areas and rooms in the building floor plan of FIG. 7.

FIG. 10 is the building floor plan of FIG. 7 further illustrating the location of an object within the building floor plan.

FIG. 11 illustrates how location accuracy can be improved in the example of FIG. 10.

FIG. 12 is a block diagram of an exemplary machine that may perform one or more of the operations described, and/or store information used and/or generated by such operations.

### §4. DETAILED DESCRIPTION

The present invention may involve novel methods, apparatus, message formats, and/or data structures to refine a zone location of a tracked object. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present invention unless explicitly described as such. Also, as used herein, the article “a” is intended to include one or more items. Where only one item is intended, the term “one” or similar language is used. Thus, the present invention is not intended to be limited to the embodiments shown and the inventor regards his invention as any patentable subject matter described.

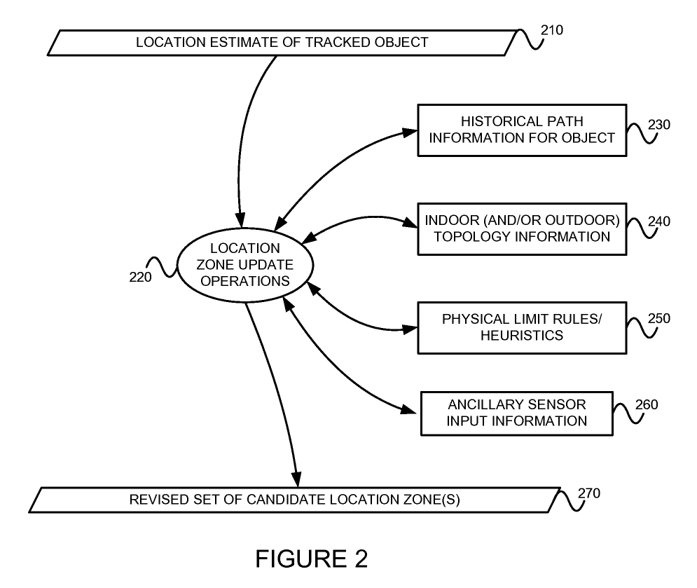

FIG. 2 is a bubble diagram of operations that may be performed in accordance with the present invention, and information that may be used and/or generated by such operations. More specifically, location zone update operations 220 accept a location estimate (e.g., coordinates) of a tracked object 210 and output a revised set of one or more candidate location zones which may include the tracked object. The location zone update operations 220 may use historical path information 230 of the object, indoor (and/or outdoor) topology information 240, physical limit rules (heuristics) 250 and ancillary sensor input information 260. Exemplary methods for performing location zone update operations 220 are described in §4.1 below.

§4.1 Exemplary Methods Consistent with the Present Invention

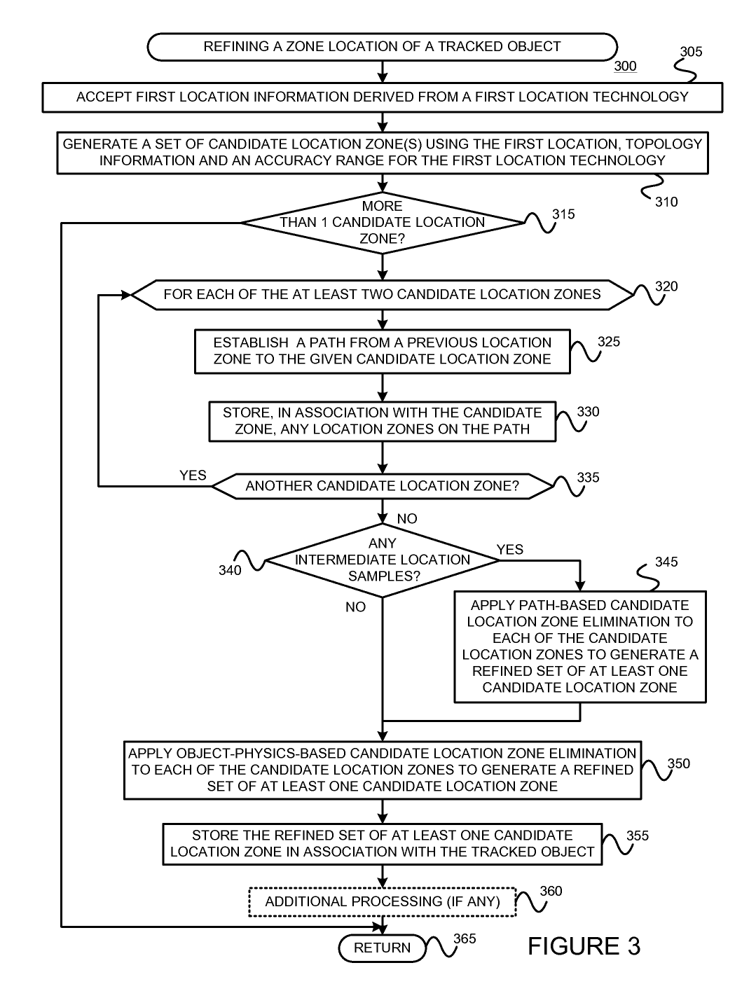

FIG. 3 is a flow diagram of an exemplary method 300 for refining a zone location of a tracked object. First location information derived from a first location technology (provided by a first locationing system, such as RF ID for example) is accepted. (Block 305) Then, a set of one or more candidate location zones are generated using the first location, topology information and an accuracy range for the first location technology. (Block 310) If there are more than one candidate location zones, the method 300 continues; otherwise, the method 300 is left since there is no ambiguity to resolve. (Condition 315, block 320 and node 365)

Assume that there are more than one (i.e., at least two) candidate location zones. For each of at the least two candidate location zones (Loop 320-335), a path from a previous location zone to the given candidate location zone is established (Block 325) and any location zones on the path are stored in association with the candidate zone (Block 330).

If there are any intermediate location samples (since the previous location zone was determined), a path-based candidate location zone elimination process is applied to each of the at least two candidate location zones to generate a refined set of at least one candidate location zone (Condition 340 and block 345) before the method 300 continues to block 350. If, on the other hand, there are no intermediate location samples (or it is desired not to process such samples), an object-physics-based candidate location zone elimination process is applied to each of the at least two candidate location zones, to generate a refined set of at least one candidate location zone. (Condition 340 and block 350) In either case, the refined set of at least one candidate location zone is stored in association with the tracked object. (Block 355) Additional processing (if any) may then be performed before the method 300 is left. (Block 360 and node 365)

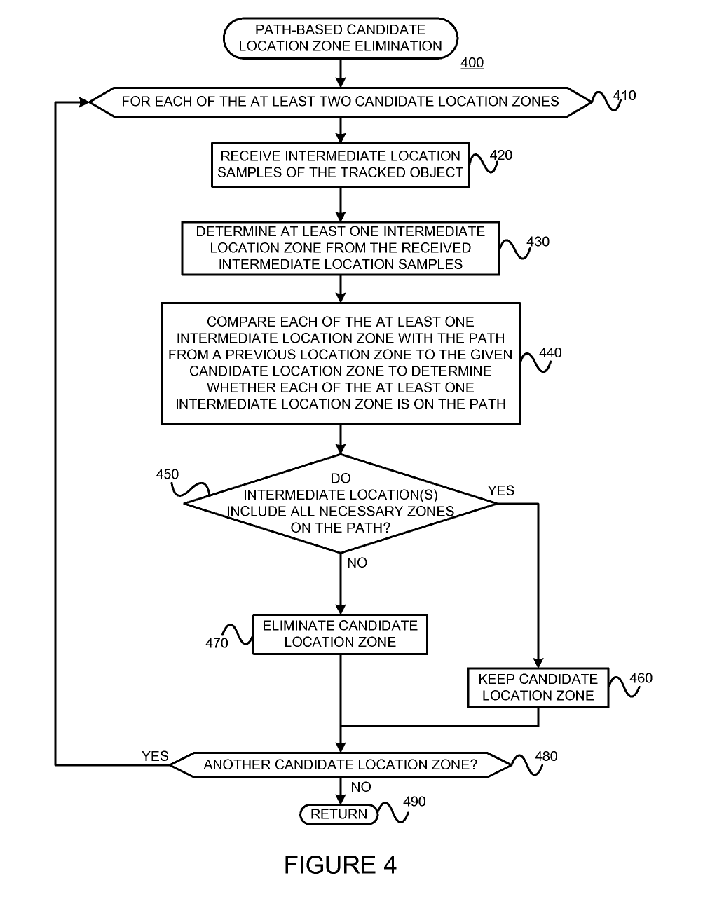

Referring back to block 345 of FIG. 3, FIG. 4 is a flow diagram of an exemplary path-based candidate location zone elimination method 400. As indicated by loop 410-480, a number of acts may be performed for each of at least two candidate location zones. More specifically, intermediate location samples of the tracked object are received. (Block 420) At least one intermediate location zone from the received intermediate location samples is determined. (Block 430) Each of the at least one intermediate location zone is then compared with the path from a previous location zone to the given candidate location zone (Recall 325 and 330 of FIG. 3.) to determine whether each of the at least one intermediate location zone is on the path. (Block 440) If the intermediate locations do not cover all necessary zones on the path (it is assumed that there are enough intermediate location samples at a sufficient frequency) (or, in an alternative embodiment, in which few intermediate samples are available, if any of the at least one intermediate location zone is not on the path), then the given candidate location zone is removed as a candidate. (Condition 450 and block 470) Otherwise, the given candidate location zone is kept as a candidate. (Condition 450 and block 460) Once all of the candidate location zones are processed, the method 400 is left. (Loop 410-480 and node 490)

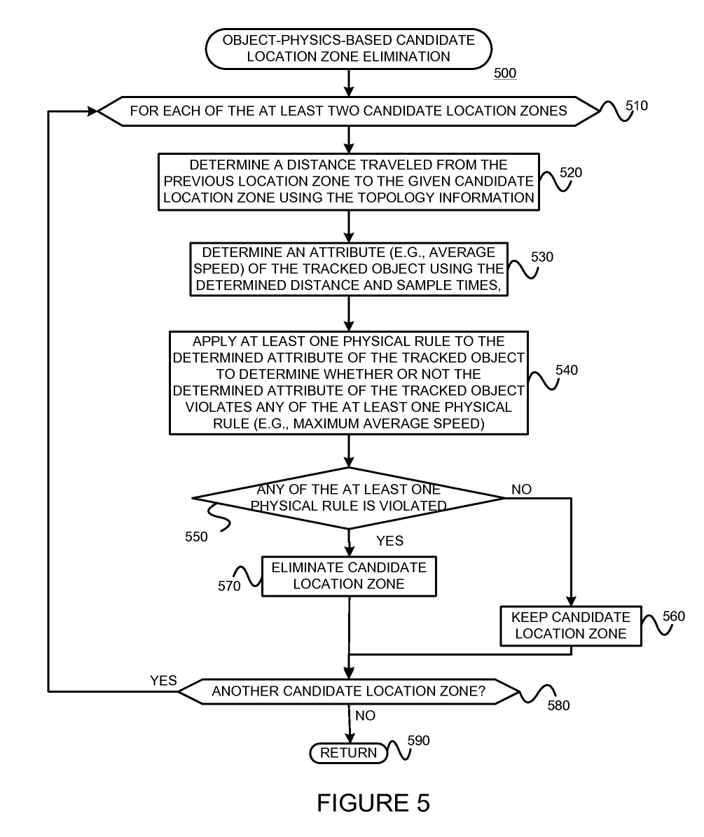

Referring back to block 350 of FIG. 3, FIG. 5 is a flow diagram of an exemplary object-physics-based candidate location zone elimination method 500. As indicated by loop 510-580, a number of acts may be performed for each of at least two candidate location zones. More specifically, a distance traveled from the previous location zone to the given candidate location zone is determined using the topology information. (Block 520) An attribute of the tracked object is determined using the determined distance and sample times. (Block 530) At least one physical rule is applied to the determined attribute of the tracked object to determine whether or not the determined attribute of the tracked object violates any of the at least one physical rule. (Block 540) If is determined that any of the at least one physical rule is violated, then the given candidate location zone is removed as a candidate. (Condition 550 and block 570) Otherwise, the given candidate location zone is kept as a candidate. (Condition 550 and block 560) Once all of the candidate location zones are processed, the method 500 is left. (Loop 510-580 and node 590)

Referring back to block 360 of FIG. 3, the method 300 may further output the refined set of at least one candidate location zone in association with a tracked object, for rendering via a user interface. Alternatively, the method 300 may further (1) receive, via a user interface, a request for a zone location of the tracked object, and (2) output, responsive the received request, the refined set of at least one candidate location zone in association with the tracked object, for rendering via a user interface.

Referring back to block 305 of FIG. 3, the first location technology may be RF-based (e.g., WiFi-based).

Referring back to blocks 310 and 330 of FIG. 3, blocks 430 and 440 of FIGS. 4, and 520 of FIG. 5, the topology information may include a floor plan of a building in which the tracked object is located. For example, establishing a path from a previous location zone to the given candidate location zone may use a graph based on a floor plan of a building in which the tracked object is located.

Referring back to blocks 530 and 540 of FIG. 5, the attribute of the tracked object determined using the determined distance and sample times may be average speed (and/or instantaneous speed, average acceleration, etc.), and the at least one physical rule applied may be a maximum speed limit (a maximum instantaneous speed limit, etc.).

Referring back to blocks 305 and 325 of FIG. 3, the first location information and previous location zone information may be location information (A) at a time of a user query for location information and/or (B) at predetermined times. Alternatively, the previous location zone may be a last reliable (according to a predetermined test) location zone. As one example, a last reliable location zone may be one based on the detection of the tracked object entering or leaving a zone based on a passive RF detector(s) positioned at a portal to/from the zone. Therefore, in most scenarios, there will be intermediate object location samples available.

§4.3 Example Illustrating Operations of Exemplary Embodiment Consistent with the Present Invention

Referring back to 230 of FIG. 2, historical path information for a tracked object may include the following. Let the path of the tracked object be p1, p2, p3 . . . at respective times t1, t2, t3 . . . , where p1, p2, p3 are coordinates or the spatial location of the object in a given reference system. The system may receive and/or compute a new location p4 of the object at time t4. It is now desired to verify and improve the location p4 of the object.

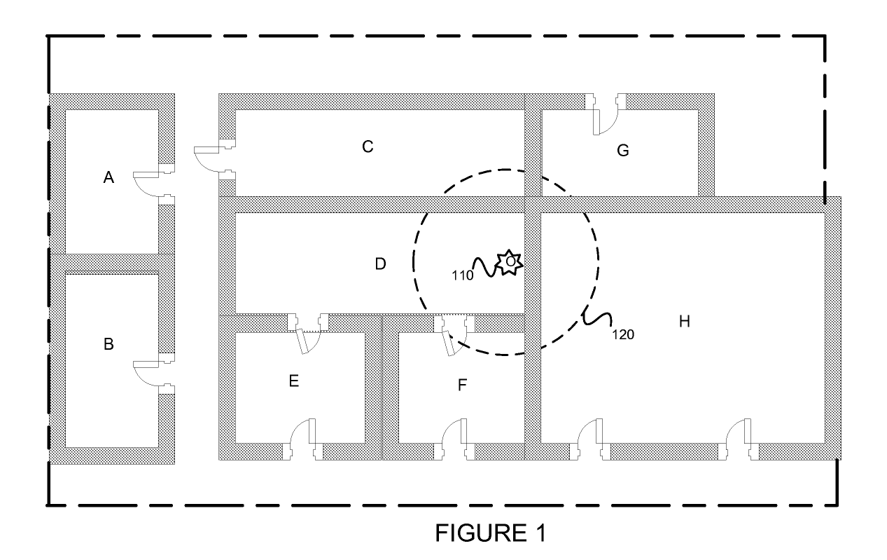

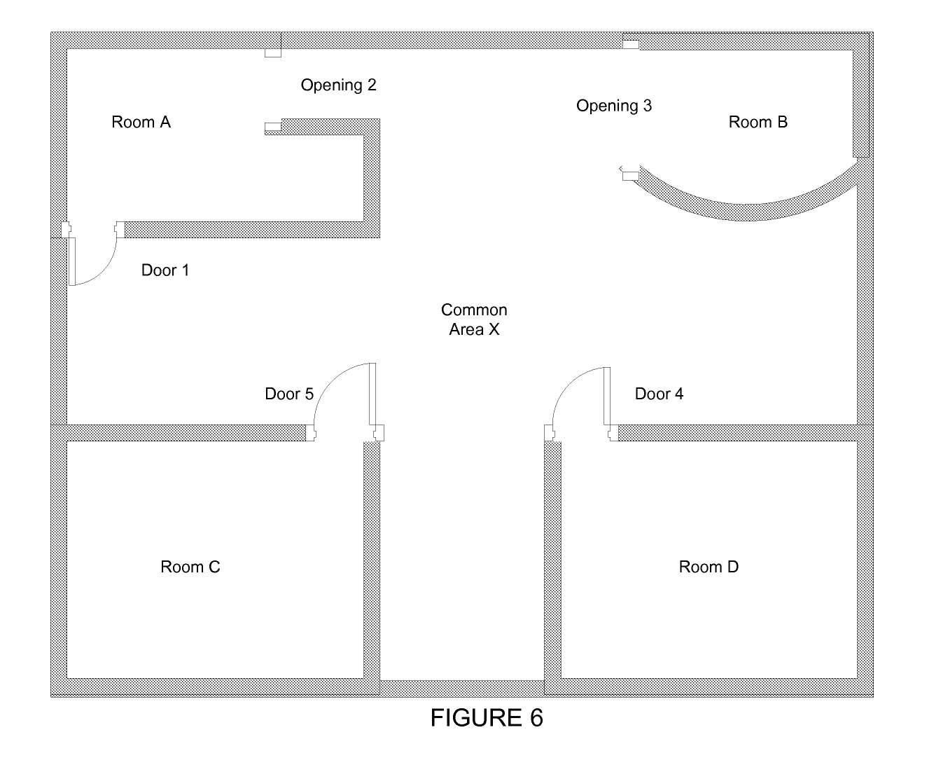

In an indoor and/or outdoor environment, the area of movement of the tracked object may be subdivided into logical sub-regions that may be virtual or real. For instance, in a hospital environment, each of these sub-regions may be identified as an emergency room area, a patient room, a surgery area, a radiology room, etc. Frequently, it is sufficient to pinpoint the location of the tracked object to one of these sub-regions. However, the physical locationing system (recall the first location technology) usually returns an estimate of the coordinates of the object which may be erroneous or not accurate enough. (Recall, for example, FIG. 1.) For example, referring to FIG. 6, the coordinates returned by a locationing system (e.g., a locationing and positioning engine) may indicate that the object is in room C even though the object is actually in room A. Similarly, if the underlying accuracy of the locationing system is 15 feet and the object is near a wall, it is important to determine which side of the wall the object is on (as that would determine the room in which the object is).

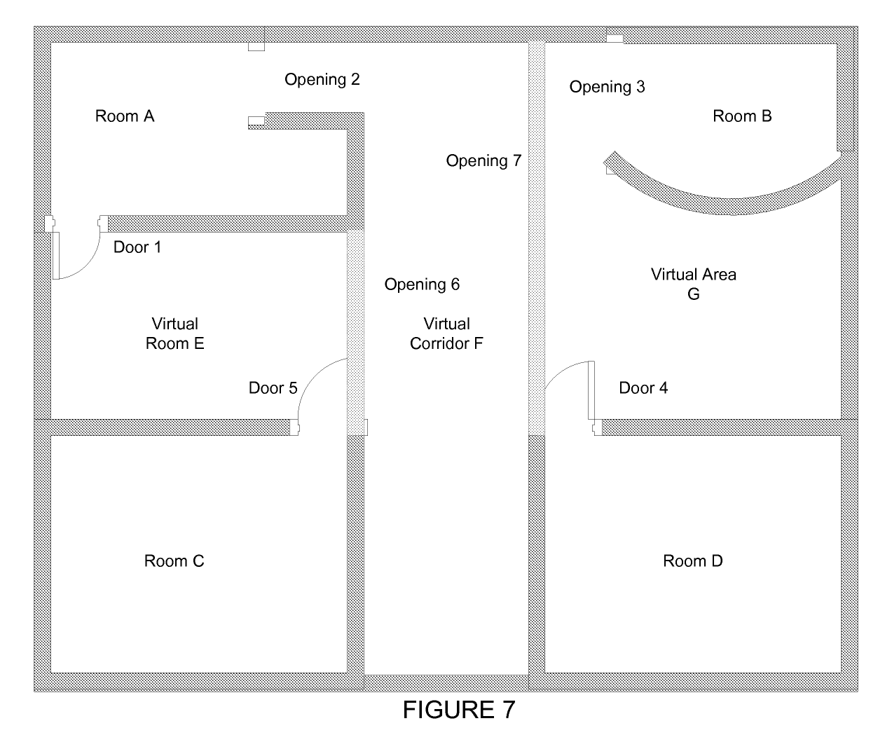

This is referred to as spatial location. Spatial regions may be real or virtual. (Compare FIGS. 6 and 7.) So for example, in a outdoor field, the sub-regions may be identified as a range of coordinate values (e.g. a grid) but the same principles apply.

Referring back to 240 of FIG. 2, the topology information may be represented as a topological graph in which there are several nodes connected by edges. Each node of the graph can represent a spatial location of interest, and edges of the graph can represent entry/exit points from the spatial location represented by one node into another spatial location represented by another node.

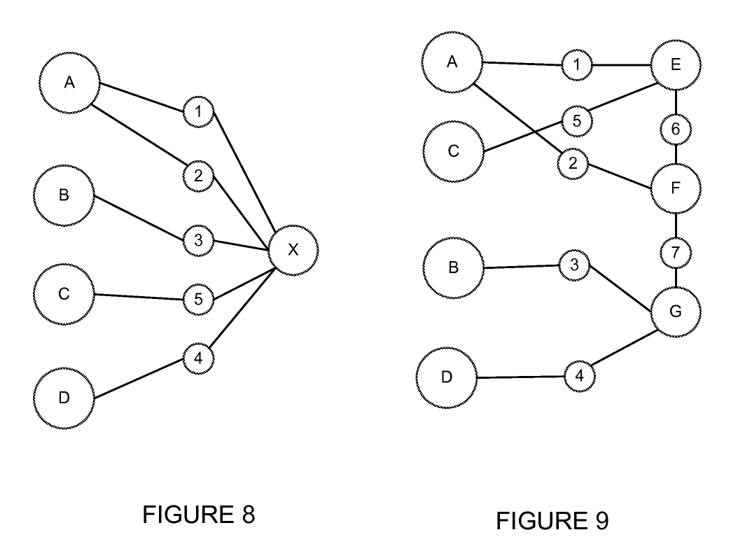

To illustrate the topological graph, consider FIG. 6 where an area has been subdivided into various regions. The graph of FIG. 8 depicts topological connectivity of rooms/areas in FIG. 6 (which depicts the doors and the rooms that a tracked object must cross to go from one room/area into another).

Often times, if there are no physical boundaries (e.g., walls, counters, etc.), or such physical boundaries are too far apart, it may be useful to partition the area into virtual rooms. Such virtual partitioning is shown in FIG. 7. The corresponding topological connectivity graph is shown in the graph of FIG. 9.

Using the partitioned area, the corresponding topological graph, distances between various points in the area, knowledge of the circle/sphere of error of the estimated location (e.g., from the first location technology system) and other object parameters like average speed, an estimate of the spatial location can be improved.

Location-dependent metrics may be applied to one or more objects at fixed time intervals, or when the location of the objects changes. The location-dependent metrics may be based on the actual coordinates of the tracked object provided by the first location technology system or the determination of logical location areas (“zones”).

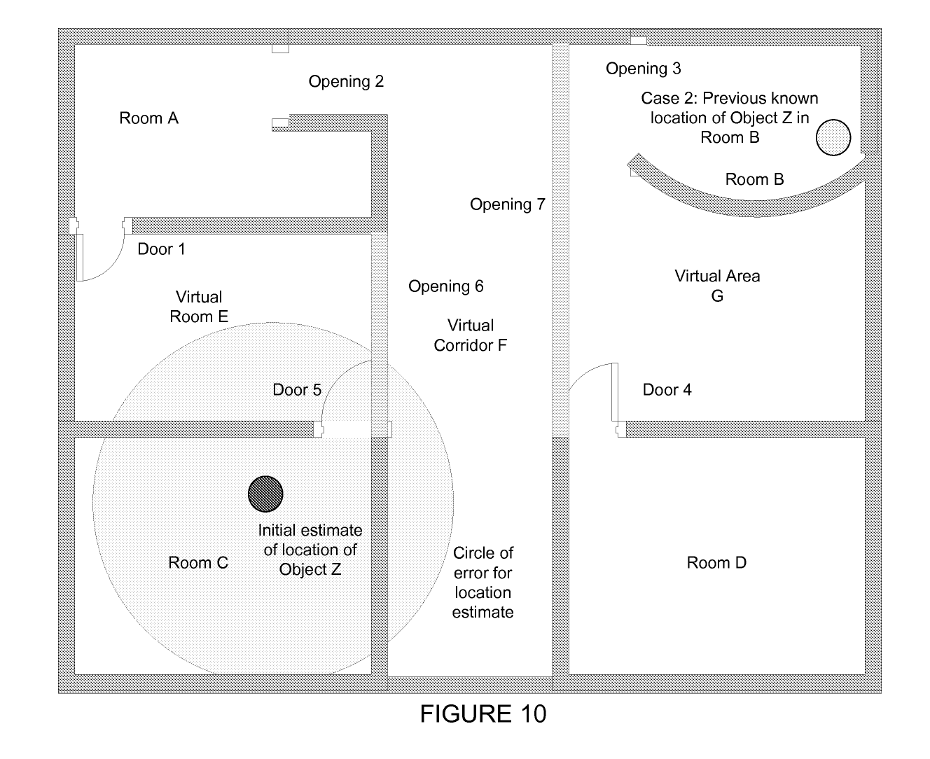

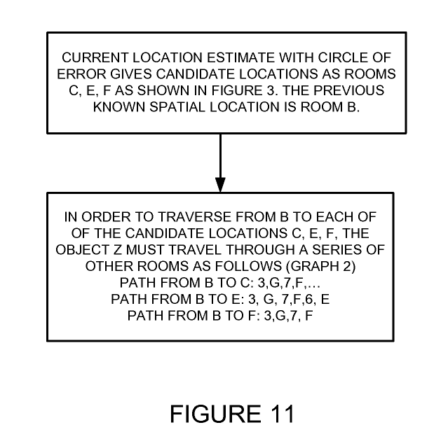

FIG. 10 shows an initial estimate of the location of a tracked object Z, as well as a circle of error for the location technology system used to provide the initial estimate. FIG. 11 illustrates a process for refining the position of the tracked object in manner consistent with the present invention. As shown in FIG. 11, the initial estimate of the location of tracked object Z is in room C. Suppose that the immediately prior known location of tracked object Z was in room B. As further shown in FIG. 11, a list of candidate rooms is generated based on the circle/sphere of accuracy of first location technology system (that is, the underlying locationing and positioning technology). So as shown in FIG. 11, given the estimate of the location of tracked object Z, the candidate zones (for true location of the object Z) are zones C, E, F.

For each of the candidate zones C, E, F, the topological graph (Recall FIG. 9.) is used to establish the zones the tracked object Z must cross to move from previous zone B to each of candidate zones C, E, F. These paths are:

B to C: 3, G, 7, F, 6, . . . ;

B to E: 3, G, 7, F, 6, . . . ; and

B to F: 3, G, 7, . . . .

If there are passive RFID readers or equivalent present at the doors and openings of the space, then the crossings of tracked object Z at those points can be detected. (Recall, e.g., additional processing block 360 of FIG. 3.) Otherwise the smaller, numbered, nodes (corresponding to portals) in the graph of FIG. 9 can be ignored.

Referring back to decision 340 of FIG. 3 as well as the method of FIG. 4, if the sampling rate of the first location technology system (e.g., locationing and positioning engine) is high enough, it may be assumed that the system would have detected intermediate zones traversed by the tracked object Z. In this scenario, suppose that tracked object Z was only detected in zone G (or not found in any intermediate zones at all if the sampling rate was too low). Under this scenario, the longer paths (to candidate zones C and E) are eliminated, and shortest distance metric is used to place tracked object Z in zone F from the candidate location zone list.

If, on the other hand, the sampling rate is too small (and there are no RFID readers at portals) (Recall, e.g., decision 340 of FIG. 3, as well as the method of FIG. 5.), then tracked object Z could have traveled from Room B to Room C without detection at an intermediate zone. In this scenario, if the average speed (or maximum average speed) of tracked object Z is S and the time interval between the last location and current location is T, then the object could have traveled a distance=S*T. Therefore distances between each of the candidate locations C, E, F and B are determined and the feasible candidate location zone(s) is/are maintained, while infeasible candidate location zone(s) are eliminated. If there is still more than one candidate location then minimum distance criteria can be imposed on the remaining candidate locations.

§4.4 Refinements, Alternatives and Extensions

Referring back to blocks 350 and 360 if there are other pieces of information available using other ancillary devices, then estimates can be improved as follows. Assuming ancillary information is available from an accelerometer associated with the tracked object, if the tracked object has not moved at all since the last reported location with certainty, then the tracked object may be placed still in room B as the sphere of error of systems is with a certain probability and never certain. If the accelerometer can provide average speed, then that can be used to more precisely place the tracked object.

Assuming ancillary information is available from a gyroscope associated with the tracked object, if turn information is provided, then the turn sequence information can be used in conjunction with the layout and the topological graph (perhaps annotated with additional turn information) to reduce errors.

Ancillary information can be provided from other sources. For example, if it is known that certain zones are hotter or colder (a kitchen, a freezer, a surgery room, etc.), a temperature sensor provided on the tracked object (together with predetermined knowledge—in this scenario, zone temperatures or temperature differentials—about the indoor topology), such ancillary information may be used to resolve a candidate zone ambiguity. For example, if it is uncertain whether the tracked object is located in a freezer or in the adjacent room, a temperature reading from the object might be used to resolve this ambiguity.

Referring back to FIG. 3, although the method 300 continued to block 350 after completion of processing at block 345, if all but one candidate location zone are eliminated (that is, if only one of the candidate location zones remain), then the method 300 can be left.

Further, the order in which blocks 345 and 350 are processed can be reversed. In general, elimination tests may be ordered in any sequence. However, it may be useful to consider information gain of the elimination test versus processing time for the elimination test. That is, it may be advantageous to perform an elimination test that has a high information gain (lots of candidate elimination) with a low processing time before another elimination test that has a low information gain with a high processing time.

§4.5 Exemplary Apparatus

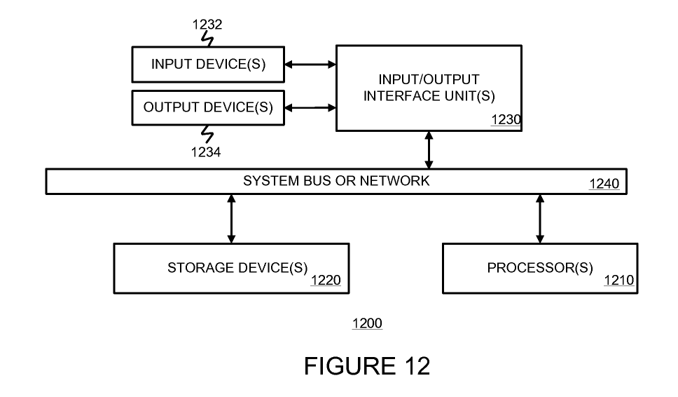

FIG. 12 is a block diagram of a machine 1200 that may perform one or more of the operations described above, and/or store information used and/or generated by such operations. The machine 1200 basically includes one or more processors 1210, one or more input/output interface units 1230, one or more storage devices 1220, and one or more system buses and/or networks 1240 for facilitating the communication of information among the coupled elements. One or more input devices 1232 and one or more output devices 1234 may be coupled with the one or more input/output interfaces 1230. The one or more processors 1210 may execute machine-executable instructions (e.g., C or C++ running on the Solaris operating system available from Sun Microsystems Inc. of Palo Alto, Calif. or the Linux operating system widely available from a number of vendors such as Red Hat, Inc. of Durham, N.C.) to effect one or more aspects of the present invention. At least a portion of the machine executable instructions may be stored (temporarily or more permanently) on the one or more storage devices 1220 and/or may be received from an external source via one or more input interface units 1230.

In one embodiment, the machine 1200 may be one or more conventional personal computers, servers, or routers. In this case, the processing units 1210 may be one or more microprocessors. The bus 1240 may include a system bus. The storage devices 1220 may include system memory, such as read only memory (ROM) and/or random access memory (RAM). The storage devices 1220 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media. The storage devices 1220 may store processor-executable program instructions which, when executed by the at least one processor 1210, perform any of the foregoing operations and/or methods. The storage devices 1220 may also store information used, and/or generated, by such operations and/or methods.

A user may enter commands and information into the personal computer through input devices 1232, such as a keyboard and pointing device (e.g., a mouse) for example. Other input devices such as a microphone, a joystick, a game pad, a satellite dish, a scanner, or the like, may also (or alternatively) be included. Location information, such as information for example, may be received from the locationing system via one or more input interfaces 1230. These and other input devices are often connected to the processing unit(s) 1210 through an appropriate interface 1230 coupled to the system bus 1240. The output devices 1234 may include a monitor or other type of display device, which may also be connected to the system bus 1240 via an appropriate interface. In addition to (or instead of) the monitor, the personal computer may include other (peripheral) output devices (not shown), such as speakers and printers for example.

Thus, at least some features of the present invention may be implemented as computer-executable software (program instructions). Alternatively, or in addition, at least some features of the present invention may be implemented in hardware (e.g., as application specific integrated circuits (ASICS)). In some embodiments consistent with the present invention, operations such as those described above may be performed, at least in part, on the tracked object itself.

§4.6 Conclusions

As can be appreciated from the foregoing, embodiments consistent with the claimed invention consider various techniques, which can be applied alone or in combination, to improve the estimation of location of objects irrespective of the technology employed to track them. Such techniques may include one or more of (1) historical path information of the tracked object, (2) knowledge of the topology of indoor and/or outdoor terrain, (3) understanding of physics (such as how fast is the object moving, what capabilities it may have, etc.), (4) information from ancillary sensor devices (such as, for example, gyroscopes, accelerometers, temperature sensors, etc.), and (5) multiple tags using one or more different tagging technologies.

What is claimed is:

1. A computer-implemented method for refining a zone location of a tracked object, the computer-implemented method comprising:
a) accepting, by a computer system including at least one computer, first location information derived from a first location technology;
b) generating, by the computer system, a set of at least two candidate location zones using the first location, topology information and an accuracy range for the first location technology;
c) for each of the at least two candidate location zones,
1) establishing, by the computer system, a path from a previous location zone to the given candidate location zone, and
2) storing, by the computer system and in association with the candidate zone, any location zones on the path;
d) applying, by the computer system, at least one of (A) path-based candidate location zone elimination to each of the at least two candidate location zones, and (B) object-physics-based candidate location zone elimination to each of the at least two candidate location zones, to generate a refined set of at least one candidate location zone; and
e) storing, by the computer system, the refined set of at least one candidate location zone in association with the tracked object.

2. The computer-implemented method of claim 1 further comprising:
f) outputting, by the computer system, the refined set of at least one candidate location zone in association with a tracked object, for rendering via a user interface.

3. The computer-implemented method of claim 1 further comprising:
f) receiving, by the computer system and via a user interface, a request for a zone location of the tracked object; and
g) outputting, by the computer system and responsive the received request, the refined set of at least one candidate location zone in association with the tracked object, for rendering via a user interface.

4. The computer-implemented method of claim 1 wherein the first location technology is RF-based.

5. The computer-implemented method of claim 1 wherein the first location technology is WiFi-based.

6. The computer-implemented method of claim 1 wherein the topology information includes a floor plan of a building in which the tracked object is located.

7. The computer-implemented method of claim 1 wherein the act of establishing, by the computer system, a path from a previous location zone to the given candidate location zone uses a graph based on a floor plan of a building in which the tracked object is located.

8. The computer-implemented method of claim 1 wherein the computer system applies the path-based candidate location zone elimination to each of the at least two candidate location zones.

9. The computer-implemented method of claim 8 wherein the path-based candidate location zone elimination applied by the computer system includes
1) receiving intermediate location samples of the tracked object,
2) determining at least one intermediate location zone from the received intermediate location samples,
3) comparing each of the at least one intermediate location zone with the path from a previous location zone to the given candidate location zone to determine whether each of the at least one intermediate location zone is on the path, and
4) when the at least one intermediate location zone do not cover all necessary zones on the path, then removing the given candidate location zone as a candidate, otherwise keeping the given candidate location zone as a candidate.

10. The computer-implemented method of claim 1 wherein the computer system applies the object-physics-based candidate location zone elimination to each of the at least two candidate location zones.

11. The computer-implemented method of claim 10 wherein the object-physics-based candidate location zone elimination applied by the computer system includes
1) determining a distance traveled from the previous location zone to the given candidate location zone using the topology information,
2) determining an attribute of the tracked object using the determined distance and sample times,
3) apply at least one physical rule to the determined attribute of the tracked object to determine whether or not the determined attribute of the tracked object violates any of the at least one physical rule, and
4) when it is determined that any of the at least one physical rule is violated, then removing the given candidate location zone as a candidate, otherwise, keeping the given candidate location zone as a candidate.

12. The computer-implemented method of claim 11 wherein the attribute of the tracked object determined using the determined distance and sample times is average speed, and wherein the at least one physical rule applied is a maximum speed limit.

13. Apparatus for refining a zone location of a tracked object, the apparatus comprising:
a) at least one processor; and
b) at least one storage device storing processor-executable program instructions which, when executed by the at least one processor, perform a method of,
1) accepting first location information derived from a first location technology,
2) generating a set of at least two candidate location zones using the first location, topology information and an accuracy range for the first location technology,
3) for each of the at least two candidate location zones,
establishing a path from a previous location zone to the given candidate location zone, and
storing, in association with the candidate zone, any location zones on the path,
4) applying at least one of (A) path-based candidate location zone elimination to each of the at least two candidate location zones, and (B) object-physics-based candidate location zone elimination to each of the at least two candidate location zones, to generate a refined set of at least one candidate location zone, and
5) storing the refined set of at least one candidate location zone in association with the tracked object.
